(19) United States
(12) Patent Application Publication
(10) Pub. No.: US 2025/0229809 A1
(43) Pub. Date: Jul. 17, 2025

(54) Method for Assisting in the Activation of an Automated Driving Function of a Vehicle, Computer Program, Control Unit, and Vehicle

(71) Applicant: Bayerische Motoren Werke Aktiengesellschaft, Muenchen (DE)

(72) Inventors: Yannick FORSTER, Muenchen (DE); Frederik NAUJOKS, Muenchen (DE)

(21) Appl. No.: 18/702,739

(22) PCT Filed: Sep. 16, 2022
(86) PCT No.: PCT/EP2022/075718

§ 371 Date: Apr. 18, 2024

(30) Foreign Application Priority Data
Oct. 19, 2021 (DE) 10 2021 127 068.5

(51) Int. Cl. B60W 60/00; B60W 30/12

(52) U.S. Cl. CPC B60W 60/0051; B60W 30/12

(57) ABSTRACT

A method is disclosed for assisting in an activation of an automated driving function of a vehicle that includes at least one driving-assistance system configured to influence the driving situation of the vehicle as soon as an activation threshold is reached. The method includes determining a current driving situation of the vehicle; ascertaining that the current driving situation of the vehicle differs from a specified driving situation in which the automated driving function can be activated; and adapting the activation threshold and/or an intervention characteristic of the at least one driving-assistance system.

### CROSS REFERENCE TO RELATED APPLICATION

This application is a 371 of International Application No. PCT/EP2022/075718, filed Sep. 16, 2022 which claims priority under 35 U.S.C. § 119 from German Patent Application No. 10 2021 127 068.5, filed Oct. 19, 2021, the entire disclosure of which is herein expressly incorporated by reference.

### BACKGROUND AND SUMMARY

The present invention relates to a method for assisting in an activation of an automated driving function of a vehicle. The present invention also relates to a computer program that, when it is executed in a computing unit, is designed to execute the method. The present invention also relates to a control unit that has been configured to execute the method. The present invention also relates to a vehicle with the control unit.

Vehicles are known in the prior art that are able to drive in automated manner by means of an automated driving function. Automated driving functions of vehicles (for example, SAE Level 2, L2, and higher) may require certain preconditions in order to allow an activation of the automated driving function by a user. Such a precondition may be, for instance, a minimum or maximum spacing from a vehicle traveling ahead. In conventional systems, such conditions usually have to be actively established by a user of the vehicle before an activation can be initiated and can also be maintained within the initialization process. Since these conditions may be complex and, in some cases, difficult for the user or driver to comprehend, the communication thereof, for instance by means of a visual interface of the vehicle, on the one hand represents a source of distraction and on the other hand may bring about a cognitive overloading of the driver.

Against the background of this prior art, an object of the present invention relates to a method and a device that are each suitable to overcome at least the aforementioned disadvantages of the prior art.

Accordingly, a method is disclosed for assisting in an activation of an automated driving function of a vehicle, the vehicle including at least one driving-assistance system that has been configured to influence a driving situation of the vehicle as soon as an activation threshold is reached.

The method comprises determining a current driving situation of the vehicle, ascertaining that the current driving situation of the vehicle differs from a specified driving situation in which the automated driving function can be activated, and adapting the activation threshold and/or an intervention characteristic of the at least one driving-assistance system.

In comparison with the prior art, this offers the advantage that driving-assistance systems integrated and activated within the vehicle may have a variable activation threshold and can consequently influence a driving situation of the vehicle earlier at the time of an adaptation of this activation threshold. By virtue of this measure, an offer of low-threshold assistance for the activation of a further vehicle automation that has not yet been activated can be actively made to the driver through short-term and subtle interventions in the guidance of the vehicle. As a result, the driver can be prevented from being distracted and/or cognitively overtaxed. In addition, by virtue of an early intervention of the at least one driving-assistance system the current driving situation can be brought in the direction of, or toward or into, the specified driving situation. As a result, a transition from a low autonomy level to a higher autonomy level (for instance, from a partially automated driving function to a conditional automated driving function or to a highly automated driving function) can be simplified for the user.

The vehicle may be a motor vehicle, optionally an automobile. The motor vehicle is an automated motor vehicle. The automated motor vehicle may have been configured to take over transverse guidance and/or longitudinal guidance at least partially and/or temporarily in the course of automated driving of the motor vehicle.

The automated driving may occur in such a way that the locomotion of the motor vehicle occurs (largely) autonomously.

The motor vehicle may be a motor vehicle pertaining to Autonomy Level 1—that is to say, it may exhibit certain driver-assistance systems that assist the driver in operating the vehicle, such as adaptive cruise control (ACC), for instance.

The motor vehicle may be a motor vehicle pertaining to Autonomy Level 2—that is to say, it may have been partially automated in such a way that functions such as automatic parking, lane-keeping or lateral guidance, general longitudinal guidance, accelerating and/or decelerating are taken over by driver-assistance systems.

The motor vehicle may be a motor vehicle pertaining to Autonomy Level 3—that is to say, it may be conditionally automated in such a way that the driver does not have to monitor the vehicle system continuously. The motor vehicle carries out functions such as the triggering of the turn signal, change of lane and/or lane-keeping independently. The driver can direct his/her attention to other things but, if need be, is invited by the system within an advance-warning time to take over the guidance.

The motor vehicle may be a motor vehicle pertaining to Autonomy Level 4—that is to say, it may be highly automated in such a way that the guidance of the vehicle is taken over by the vehicle system permanently. If the driving tasks are no longer being managed by the system, the driver can be invited to take over the guidance.

The motor vehicle may be a motor vehicle pertaining to Autonomy Level 5—that is to say, it may be fully automated in such a way that the driver is not required for the purpose of fulfilling the driving task. Besides the setting of the destination and the starting of the system, no human intervention is required. The motor vehicle can manage without steering wheel and pedals.

The method for assisting in the activation of the automated driving function of the vehicle can assist (that is to say, help) a user (for instance, a driver) to initiate (that is to say, to activate) the automated driving function of the vehicle. The method may also be designated as an activation assistant for automated driving functions.

The automated driving function may be understood to be one of the aforementioned autonomy levels starting from Autonomy Level 2 (that is to say, at least Autonomy Level 2 or higher). In other words, the automated driving function can provide at least a partial automation of the vehicle. Accordingly, the automated driving function cannot correspond to Autonomy Level 1. The user can activate the automated driving function as desired. Once the automated driving function has been activated, it is possible that the user does not have to monitor the automated driving function permanently. The user can consequently be relieved and, in certain cases, can be invited to take over the driving task at the right time. In the case of fully automated driving, it is possible that the user no longer has to monitor the automated driving function at all. The automated driving function may, for instance, be capable of being activated only when a specified driving situation obtains. In other words, the activating of the automated driving function may have a certain precondition or certain preconditions as regards the current driving situation of the vehicle. This will be described in further detail in the following.

The at least one driving-assistance system may be, for instance, an adaptive cruise control (ACC), a lane-keeping assistant, a lane-keeping warning system or a speed-regulating system. Furthermore, further driving-assistance systems that assist the driving of the vehicle may also have been provided in the vehicle. For instance, several driving-assistance systems may also have been provided in the vehicle in parallel, all or only some of which have been activated.

The speed-regulating system may be a device in the vehicle that regulates a speed of the vehicle—for example, by means of a regulation of an engine speed of a prime mover of the vehicle—in automated manner in such a way that the vehicle maintains a speed specified by the user and/or by a further system. The adaptive cruise control may comprise a speed-regulating system which in the course of the regulation of the speed takes into account, in addition, the spacing from a vehicle traveling ahead as an additional feedback variable and controlled variable. The lane-keeping assistant may be a system that assists the user in keeping a safe vehicle position with respect to the boundary of the lane and/or road, at least whenever the vehicle is departing from the lane and/or is about to depart therefrom. The assistance provided by the lane-keeping assistant may include an active intervention in the lateral guidance of the vehicle, for instance by means of a steering intervention that keeps the vehicle in the lane, where appropriate to the extent that the user does not counter-steer. The lane-keeping warning system (also designated as a passive lane-keeping assistant) may be a system that warns the user whenever the vehicle departs from a current lane, in particular inadvertently.

Both the automated driving function and the at least one driving-assistance system may have been assigned to one of the aforementioned autonomy levels. In this connection, the at least one driving-assistance system is able to realize merely some of the automation of the respective autonomy level, whereas the automated driving function is able to realize several or all of the automations of the respective autonomy level. Furthermore, the at least one driving-assistance system may have been assigned to a lower autonomy level than the automated driving function. In other words, the autonomy level of the automated driving function may be higher than the autonomy level of the at least one driving-assistance system. Furthermore, the at least one driving-assistance system may have been activated, in particular at the start of the method, whereas the automated driving function has not yet been activated, in particular at the start of the method. Consequently the at least one driving-assistance system is able to draw the attention of the user to the automated driving function by influencing the current driving situation, and/or is able to facilitate the transition from a currently active autonomy level to a higher autonomy level. Furthermore, by provision of an adaptable activation threshold of the at least one driving-assistance system, such a prompt for the user, and/or a facilitated transition, can be provided in good time. As a result, using the automated driving function can be urged upon the user and/or made easier for the user.

For instance, the at least one driving-assistance system may have been assigned to Autonomy Level 1 (for instance, the driving-assistance system may be an adaptive cruise control), and the automated driving function may have been assigned to Autonomy Level 2 (for instance, the automated driving function may comprise a lane-keeping assistant). In other words, the automated driving function may have been assigned to a higher autonomy level than the at least one driving-assistance system. According to another example, the at least one driving-assistance system has been assigned to Autonomy Level 2, and the automated driving functions have been assigned to Autonomy Level 3. Likewise, it is conceivable that the at least one driving-assistance system has been assigned to Autonomy Level 2, and the automated driving function has been assigned to Autonomy Level 4.

Increasing the autonomy level when activating the automated driving function (for instance, from Autonomy Level 2 to Autonomy Level 3) may presuppose a specified driving situation of the vehicle (for example, certain preconditions) in order to allow an activation of a higher autonomy level by the user. As a result, it can be ensured that driving safety of the vehicle is currently provided and will also continue to be provided as soon as a higher degree of automation is activated. The specified driving situation may have been defined, for instance, by a minimum or maximum spacing from a vehicle traveling ahead, by the maintaining of a certain speed (not faster or slower than a defined range), and/or by driving within a defined tolerance range around the middle of the lane. Consequently the at least one driving-assistance system can help to establish the specified driving situation and to facilitate or to bring about the activation of a higher autonomy level.

The current driving situation may be a position and/or speed of the vehicle relative to other road users, objects and/or markings. The driving situation can be determined in real time, so that dynamically changing boundary conditions can also be taken into account continuously. The current driving situation can be captured by a capture system which may have been configured to capture the vehicle environment, in particular the contour of a lane, as well as current driving parameters such as speed, steering angle and/or an activation of the direction-indicator. For this purpose, the capture system may exhibit suitable sensorics. Consequently, the current driving situation of the vehicle can be determined continuously.

The activation threshold may be a predetermined driving situation, starting from which the at least one driving-assistance system is activated in order to influence the current driving situation of the vehicle (for example, to alter it directly). For instance, the activation threshold may have been defined by a spacing between the vehicle and the lane marking on the road. If the vehicle comes too close to the lane marking (that is to say, if the activation threshold is reached or fallen below), a lane-keeping assistant, for instance, becomes active which influences the driving situation so that the vehicle moves away from the lane marking. In this case, the activation threshold may, for instance, have been defined in such a way that it is reached as soon as at least one wheel of the vehicle touches the lane marking. According to a further embodiment, the activation threshold may be a minimum or maximum speed of the vehicle. In this case, the speed-regulating system can intervene, in order to influence the driving situation in such a way that the speed of the vehicle moves away from the activation threshold (that is to say, increases or decreases).

By virtue of an adaptation of the activation threshold, the point in time from which the at least one driving-assistance system intervenes in order to influence the current driving situation can accordingly be regulated. In other words, the activation threshold of the at least one driving-assistance system may be variable. As soon as it is ascertained that the current driving situation of the vehicle differs from the specified driving situation that is necessary in order to activate an automated driving function (that is to say, a higher autonomy level), the activation threshold of the at least one driving-assistance system can be adapted. In the case of several driving-assistance systems, each activation threshold of each driving-assistance system can be adapted, or only the activation threshold of individual driving-assistance systems can be adapted. It is also conceivable that, depending on the difference between the current driving situation and the specified driving function, either all the activation thresholds of the driving-assistance systems are adapted (for instance, in the case of a large difference) or only individual activation thresholds (for instance, in the case of a smaller difference) are adapted. It can consequently be ensured that the current driving situation is not altered (that is to say, influenced) abruptly by the driving-assistance systems, and consequently a high degree of driving comfort is maintained.

Consequently, if the user attempts to activate highly automated (SAE L3) or fully automated driving (SAE L4), and the current driving situation (for example, speed, lane position, spacing from the vehicle in front) differs from the specified driving situation, the activation threshold can be adapted at least by one of the existing and activated assistance systems until the specified driving situation is attained and activation of highly automated (SAE L3) or fully automated driving (SAE L4) has been concluded.

In other words, by an adaptation of the activation thresholds and/or intervention characteristics of existing driver-assistance systems a change to a higher autonomy level can be simplified. For instance, keeping the vehicle in the middle of the lane can be assisted by a lane-departure warning system issuing a warning earlier or intervening in the steering earlier prior to departure from the lane. Keeping a minimum spacing from the vehicle in front can be achieved by an earlier intervention of a braking-force assistance system. The maintaining of a maximum speed can be assisted by a speed-regulating system (for example, a speed-limiter) being briefly engaged. By virtue of these measures, an offer of low-threshold assistance for the activation of vehicle automation (that is to say, of an automated driving function pertaining to a higher autonomy level) can be actively made to the user through short-term and subtle interventions in the guidance of the vehicle.

The adaptation of the activation threshold and/or of the intervention characteristic may be an alteration of the activation threshold and/or of the intervention characteristic. The activation threshold may be, for instance, a certain numerical value such as, for instance, a minimum spacing from a vehicle traveling ahead, a spacing from a lane marking, and/or a maximum or minimum speed of the vehicle. The intervention characteristic may, for instance, be the manner in which the driving-assistance system brings an influence to bear on the running of the vehicle. For instance, the intervention characteristic may be a numerical percentage value by which, for example, the current steering lock is changed in order to adapt the current driving situation. Furthermore, the intervention characteristic may be a numerical percentage value by which, for example, the current engine speed is increased or decreased in order to reduce or to enlarge a spacing from a vehicle traveling ahead. The step of adapting the activation threshold and/or the intervention characteristic may consequently include a reduction or an increase of a numerical value. According to an advantageous embodiment, the adaptation of the numerical value that characterizes the activation threshold and/or the intervention characteristic occurs within a range from 0.2% to 30%, compared to the initial value. Within this range, an optimal adaptation to a great number of driving situations can be created. According to a further embodiment, the adaptation of the numerical value that characterizes the activation threshold and/or the intervention characteristic occurs within a range from 1% to 20%, compared to the initial value. It has been found that within this range a particularly smooth transition to a higher autonomy level in the course of freeway journeys is possible.

Immediately after the step of adapting the activation threshold and/or the intervention characteristic, the method can be run through again. Accordingly, it can be ascertained again whether or not the specified driving situation has been attained. Consequently, the activation threshold and/or the intervention characteristic can be adapted in increments in the course of each pass of the method. The number of passes of the method may have been limited to three passes. In this connection, sufficient assistance can be offered for the user to activate the automated driving function without the activation threshold and/or the intervention characteristic being adapted excessively. Immediately after the three passes, the activation threshold and the intervention characteristic can be reset to the original values.

Over and above this, the intervention characteristic of the at least one driving-assistance system may include the type of intervention of the driving-assistance system in order to influence the current driving situation. For instance, a lane-keeping assistant (as an example of a driving-assistance system) can, before it actively intervenes in the steering of the vehicle, normally give the user a signal that the vehicle will, for instance, soon depart from the lane. This may be designated as an early-warning system. By adapting the intervention characteristic, the lane-keeping assistant can, instead of the output of the signal, also intervene directly in the steering of the vehicle in order to influence the current driving situation of the vehicle earlier. In this case, an activation threshold is accordingly not adapted, but merely the intervention characteristic is adapted. Furthermore, it is conceivable to adapt both the intervention characteristic and the activation threshold. Consequently, the system can react individually to a difference between the current driving situation and the specified driving situation. As a result, elevated requirements as regards an NVH property (noise, vibration, harshness) during a transition between autonomy levels may have been ensured.

According to an advantageous embodiment, the method further includes activating the at least one driving-assistance system in order to influence the current driving situation of the vehicle.

In other words, the current driving situation can be presented in such a way that an adapted activation threshold of at least one driving-assistance system is attained, so that the at least one driving-assistance system becomes active. The at least one driving-assistance system can then influence the current driving situation directly or indirectly. An indirect influencing may occur, for instance, by output of a warning or of a prompt to the user. The user can then alter the driving situation of the vehicle. A direct influencing may be, for instance, through direct intervention of the at least one driving-assistance system in the running of the vehicle. For instance, the driving-assistance system can actuate the steering system of the vehicle in order to alter the position of the vehicle relative to the lane. Furthermore, the driving-assistance system can, for instance, increase or decrease the speed of the vehicle in order to establish the specified driving situation. Regardless of whether the at least one driving-assistance system influences the current driving situation directly or indirectly, through the activating of the driving-assistance system(s) the specified driving situation can be brought about, in which an activation of the automated driving function has been made possible. Consequently, a change of the autonomy level to a higher autonomy level can be facilitated for the user and generally simplified.

According to a further embodiment, the activation threshold and/or the intervention characteristic of the at least one driving-assistance system are/is adapted in time-limited manner.

As described above, the activation threshold and/or the intervention characteristic can be adapted in order to create the possibility of having an effect on the current driving situation earlier than without the adaptation. According to this embodiment, the adapting of the activation threshold and/or of the intervention characteristic can occur for only a predetermined period of time. After this period of time, the activation threshold and/or the intervention characteristic can be reset to the initial state existing prior to the adaptation. Consequently, the assisting in the activation of the automated driving function can be provided only for a certain period of time. Regardless of whether or not the automated driving function is activated, the assistance may come to an end after this period of time. Alternatively, as described above, the method may be run through several times within a certain period of time, in order consequently to adapt the activation threshold and/or the intervention characteristic again if the driving situation prevailing in the given case differs from the specified driving situation. According to a further embodiment, the adapting of the activation threshold and/or of the intervention characteristic can be brought to an end (that is to say, reset to the original settings) either after a certain period of time has elapsed (a so-called time-out) or in the event of an activation of the automated driving function. This offers the advantage that, after activation of the automated driving function has occurred, the activation threshold and/or the intervention characteristic at the higher autonomy level correspond(s) again to their/its original settings and therefore do/does not adversely affect the automated driving function of the vehicle.

In at least one embodiment, the driving situation of the vehicle encompasses a speed of the vehicle, a lane position of the vehicle, and/or a maximum or minimum spacing of the vehicle from a vehicle traveling ahead.

The speed of the vehicle may be a relative speed of locomotion of the vehicle relative to an undersurface on which the vehicle is traveling. The speed may have been specified in a distance per unit time. The lane position of the vehicle may be a position of the vehicle relative to boundaries and/or markings defining the lane. The lane position may be the shortest spacing of the vehicle from boundaries and/or markings that define the lane. The lane position may have been specified in a unit of length. The maximum or minimum spacing of the vehicle from a vehicle traveling ahead may be a distance between a foremost point of the vehicle and a hindmost point of the vehicle traveling ahead.

In at least one embodiment, the method further includes activating the automated driving function as soon as the specified driving situation has been maintained for a predetermined period.

The step of activating the automated driving function may occur after it has been ascertained that the current driving situation corresponds to the specified driving situation. This may be the case, for instance, after the activation threshold and/or the intervention characteristic have/has been adapted at least once. Activating the automated driving function can be initiated in at least the following three ways:
I. After the user has been made aware, by the adapting of the activation threshold and/or of the intervention characteristic, that an automated driving function is available, and actively activates the automated driving function,
II. Automatically, after the specified driving situation has been ascertained which was attained, for instance, by the adapting of the activation threshold and/or of the intervention characteristic, or
III. The user attempts to activate the automated driving function without the specified driving situation obtaining. In this case, the above method can be carried out and, in particular, the adapting of the activation threshold and/or of the intervention characteristic may have the result that the specified driving situation for the user can be attained without difficulties. As soon as the specified driving situation then obtains, the automated driving function can be activated automatically. In other words, in the case of I. the user can give the command after the adapting of the activation threshold and/or of the intervention characteristic, whereas in the case of III. the user can give the command prior to the adapting of the activation threshold and/or of the intervention characteristic.

In at least one embodiment, the automated driving function is highly automated driving of the vehicle, fully automated driving of the vehicle, or autonomous driving of the vehicle.

Highly automated driving of the vehicle may correspond to Autonomy Level 3. In this case, as soon as the specified driving situation obtains and the automated driving function has been activated, the user can turn away from the traffic scenario permanently and delegate the driving task completely to the vehicle. By means of highly automated systems, the vehicle may be capable of driving completely independently over relatively long distances and in certain traffic situations, for example on freeway journeys. However, the user has to remain capable of taking over the driving task again within a few seconds, for example in construction-site situations.

Fully automated driving of the vehicle may correspond to Autonomy Level 4. In this case, the vehicle can steer itself independently for the predominant part of its journey. The technology for automated driving at Autonomy Level 4 has been developed so far that the self-driving car can master even highly complex urban traffic situations—for example, construction sites suddenly appearing—without intervention by the user. The user nevertheless has to be fit to drive, in order to be able to take over the driving task if need be. However, it is conceivable that the user may, for example, sleep temporarily during the journey. If the user ignores the warnings to take over the driving task, the system may have the authority to put the vehicle into a safe driving condition, such as to stop, for instance.

Autonomous driving may correspond to Autonomy Level 5. In contrast to Autonomy Levels 3 and 4, in the case of autonomous driving neither fitness to drive nor a driver's license of the user is required-steering wheel and pedals are consequently dispensable. The vehicle is able to take over all the driving functions. All the persons in the vehicle may consequently become passengers, as a result of which new possibilities for mobility can be opened up, also for people with disabilities, for example.

In at least one embodiment, the method further includes receiving a user command according to which the automated driving function of the vehicle is to be activated.

The user command can initiate the initiation of the automated driving function in accordance with points I. and III. above. The command can be received by means of a human/machine interface. For instance, the user can actuate a real or virtual actuating button.

Furthermore, a computer program is provided that, when it is executed in a computing unit, executes the above method. The computer program may comprise program code that, when it is executed in a computing unit, executes the above method. The program code may be present in any code, in particular in a code that is suitable for control systems of vehicles. Additionally, or alternatively, a computer-readable medium that includes a computer program defined above may also be provided. The computer-readable medium may be any digital data-storage unit, such as, for example, a USB stick, a fixed disk, a CD-ROM, an SD card or an SSD card. Of course, the computer program does not have to have been stored on such a computer-readable medium in order to be made available to a user, but may also be procured via the Internet.

Furthermore, a control unit is provided that has been configured to execute the above method. The control unit may be an electronic control unit (ECU) for a vehicle. The electronic control unit may be an intelligent processor-controlled unit that via a central gateway (CGW) is able to communicate with other modules and via fieldbuses such as the CAN bus, LIN bus, MOST bus and FlexRay or via automotive Ethernet together with telematic control units may constitute the on-board network of the vehicle. The electronic control unit is able to control the functions relevant to the handling properties of the motor vehicle, such as the engine management system, the power transmission, the braking system or the tire-pressure monitoring system. In addition, all the driver-assistance systems—such as, for instance, adaptive cruise control, the lane-keeping assistant, lane-change assistant, the traffic-sign recognition and traffic-signal recognition, the start-up assistant, night-vision assistant, intersection assistant, and many others—can be controlled by the electronic control unit.

Furthermore, a vehicle, in particular a passenger vehicle, with the above control unit is provided.

All the advantages that have been mentioned in connection with the method apply analogously also to features of the devices, and conversely. Conversely, individual features of the embodiments can be combined with other features of other embodiments or with other embodiments, and may consequently constitute new embodiments.

The present invention will be described in detail in the following on the basis of embodiments with reference to the figures.

### BRIEF DESCRIPTION OF THE DRAWINGS

FIG. 1 shows a schematic flowchart according to at least one embodiment of the present invention,

FIG. 2 shows a schematic flowchart according to at least one embodiment of the present invention, and

FIG. 3 shows a schematic representation of a vehicle according to at least one embodiment of the present invention.

### DETAILED DESCRIPTION OF THE DRAWINGS

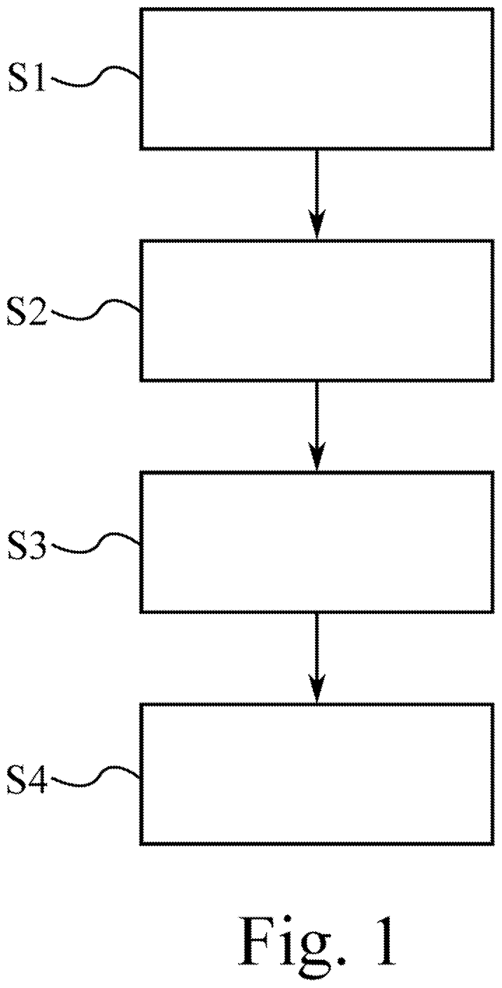

FIG. 1 is a schematic flowchart of at least one embodiment, in which a method is provided that realizes an assistance with an activation of an automated driving function of a vehicle 1.

The vehicle 1 includes at least one driving-assistance system that has been configured to influence a driving situation of the vehicle 1 as soon as an activation threshold is reached.

In FIG. 1 it can be discerned that, first of all, a first step S1 of determining a current driving situation of a vehicle 1 occurs. The driving situation of the vehicle 1 encompasses a speed of the vehicle, a lane position of the vehicle, and/or a maximum or minimum spacing of the vehicle from a vehicle traveling ahead. In other words, the driving situation of the vehicle 1 determines how the vehicle 1 is positioned relative to the environment, and/or how it is moving along.

After the first step S1, ascertaining that the current driving situation of the vehicle 1 differs from a specified driving situation in which the automated driving function can be activated occurs in a second step S2.

The ascertaining comprises comparing the current driving situation of the vehicle 1 with a specified driving situation. The comparing can be carried out by a comparator unit which has stored the specified driving situation as a precondition of an automated driving function and compares the current driving situation with the specified driving situation. The output of the comparator unit may be binary:
1. the current driving situation matches the specified driving situation, or
2. the current driving situation does not match the specified driving situation.

In the second case, in a third step S3 of the method an adapting of the activation threshold and/or of an intervention characteristic of the at least one driving-assistance system occurs.

A situation can consequently be created in which it is easier for the user to obtain the specified driving situation. In other words, a driving-assistance system or one of the driving-assistance systems does not necessarily have to be activated and intervene in the driving situation. The user can obtain the specified driving situation also after adapting the activation threshold and/or the intervention characteristic without the aid of a driving-assistance system. In this connection, a prompt by an active driving-assistance system may, for example, nevertheless assist the user.

As a next or fourth step S4, the method features an activating of the at least one driving-assistance system in order to influence the current driving situation of the vehicle 1. Here, the adapting of the activation threshold and/or of the intervention characteristic acts in such a way that at least one driving-assistance system helps the user to establish the specified driving situation. On the other hand, if the adapting of the activation threshold and/or of the intervention characteristic had not happened, the driving-assistance system might possibly not have become activated and the user might not have received any assistance (either by active intervention or by a signal) in order to attain the specified driving situation.

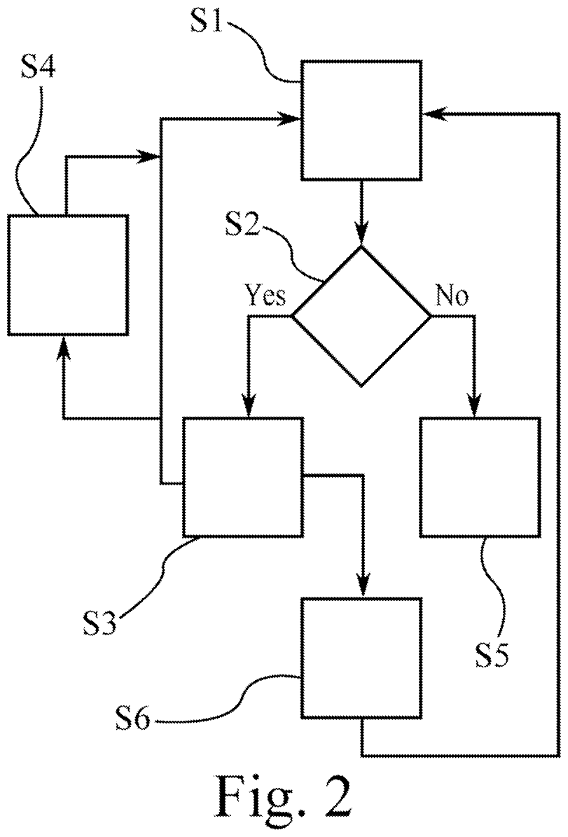

FIG. 2 is a schematic flowchart according to at least one embodiment of the present invention. In FIG. 2 it is clearly shown, in addition, how the decision-making processes according to at least one embodiment proceed. At first, the current driving situation is determined in step S1. In step S2, this situation is then compared with the specified driving situation. If the current driving position matches the specified driving function, the method proceeds to step S5, in which the automated driving function is, or can be, activated. However, the automated driving function can only be activated if the specified driving situation has been maintained for a predetermined time (for example, has been maintained for 5 s). If, on the other hand, the current driving situation does not match the specified driving function (that is to say, it differs therefrom), the method proceeds to step S3. In step S3, the activation threshold and/or the intervention characteristic are/is adapted. If thereafter neither at least one driving-assistance system is activated nor the specified driving situation is attained, the method proceeds to step S6. Step S6 is a time-out, in which the adaptation from step S3 is canceled and the activation threshold and/or the intervention characteristic consequently reassume(s) their/its initial value. The transition to step S6 is dependent on how much time has passed after step S3. In other words, the adaptation from step S3 is time-limited. After step S6, the method can start again at step S1. In this case, however, the activation threshold and/or the intervention characteristic correspond(s) to the original activation threshold and/or to the original intervention characteristic.

However, before the method proceeds to step S6, subsequent to step S3 the method may proceed again to step S1. Consequently, after an adaptation of the activation threshold and/or of the intervention characteristic the current driving situation can be determined again. In this case, step S1 is executed again, but with the adapted activation threshold and/or with the adapted intervention characteristic. The transition from step S3 to step S1 does not have to occur directly but may occur via step S4, in which at least one driving-assistance system is activated, in order to bring the vehicle into the specified driving situation more easily for the user. This procedure can be repeated several times, so long as the method does not proceed to step S6 by reason of the time elapsed since the first execution of step S3.

According to an embodiment of the present invention, the user can request the automated driving function by means of a user command. Such a command may occur prior to the first execution of step S1. Alternatively, such a command may firstly occur in step S5.

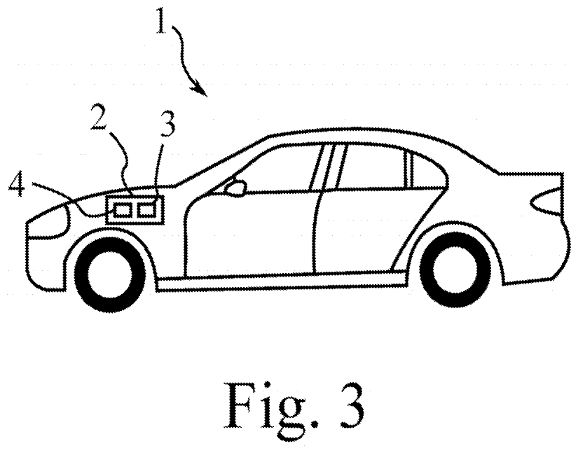

FIG. 3 is a schematic representation of a vehicle 1 according to at least one embodiment of the present invention. The vehicle in the present case is a passenger car. The vehicle 1 includes a control unit 2 that has been configured to execute the above method. The control unit 2 includes a storage unit 3 in which a computer program has been stored that comprises program code that, when it is executed by the control unit 2, is able to execute the above method. Furthermore, the control unit 2 includes a comparator unit 4 that has been configured to compare the current driving situation with a specified driving situation. The comparator unit 4 can then determine whether or not the current driving situation differs from the specified driving situation. The comparator unit 4 can obtain the specified driving situation from the storage unit 3. The specified driving situations may therefore have been saved in advance in the storage unit 3.

### LIST OF REFERENCE SYMBOLS

1 vehicle
2 control unit
3 storage unit
4 comparator unit
S1-S6 steps of the method

1-10. (canceled)

11. A method for assisting in an activation of an automated driving function of a vehicle that includes at least one driving-assistance system configured to influence a driving situation of the vehicle as soon as an activation threshold is reached, the method comprising:
determining a current driving situation of the vehicle;
ascertaining that the current driving situation of the vehicle differs from a specified driving situation in which the automated driving function can be activated; and
adapting the activation threshold and/or an intervention characteristic of the at least one driving-assistance system.

12. The method of claim 11, further comprising:
activating the at least one driving-assistance system in order to influence the current driving situation of the vehicle.

13. The method of claim 11, wherein the activation threshold and/or the intervention characteristic of the at least one driving-assistance system are/is adapted in time-limited manner.

14. The method of claim 11, wherein the driving situation of the vehicle includes: a speed of the vehicle, a lane position of the vehicle, and/or a maximum or minimum spacing of the vehicle from a vehicle traveling ahead.

15. The method of claim 11, further comprising:
activating the automated driving function as soon as the specified driving situation has been maintained for a predetermined period.

16. The method of claim 11, wherein the automated driving function is: a highly automated driving of the vehicle, a fully automated driving of the vehicle, or an autonomous driving of the vehicle.

17. The method of claim 11, further comprising:
receiving a user command according to which the automated driving function of the vehicle is to be activated.

18. A non-transitory medium storing a computer program that, when executed by a computing unit, causes the computing unit to perform the method of claim 11.

19. A control unit configured to execute the method according to claim 11.

20. A passenger vehicle comprising:
a control unit according to claim 19.
